(19) United States
(12) Patent Application Publication
(10) Pub. No.: US 2024/0175752 A1
(43) Pub. Date: May 30, 2024

(54) Systems and Methods for Compact and Low-Cost Vibrational Spectroscopy Platforms

(71) Applicant: The Board of Trustees of the Leland Stanford Junior University, Stanford, CA (US)

(72) Inventors: Jennifer A. Dionne, Menlo Park, CA (US); Ahmed Shuaibi, Stanford, CA (US); Amr A. E. Saleh, Stanford, CA (US)

(73) Assignee: The Board of Trustees of the Leland Stanford Junior University, Stanford, CA (US)

(21) Appl. No.: 18/552,628

(22) PCT Filed: Mar. 30, 2022
(86) PCT No.: PCT/US22/71446

§ 371 Date: Sep. 26, 2023

Related U.S. Application Data
(60) Provisional application No. 63/167,983, filed on Mar. 30, 2021.

(51) Int. Cl. G01J 3/44; G01J 3/02; G01N 21/65

(52) U.S. Cl. CPC G01J 3/44; G01J 3/0256; G01N 21/65; G01N 2201/1296

(57) ABSTRACT

Systems and methods for compact and low-cost vibrational spectroscopy platforms are described. Many embodiments implement deep learning processes to identify the relevant optical spectral features for the identification of an element from a set of elements. Several embodiments provide that resolution reduction and feature selection render efficient data analysis processes. By reducing the spectral data from the full wide-band high-resolution spectrum to a subset of spectral bands, a number of embodiments provide compact and low-cost hardware incorporation in spectroscopic platforms for element identification functions.

### CROSS-REFERENCE TO RELATED APPLICATIONS

The current application claims the benefit of and priority to U.S. Provisional Patent Application No. 63/167,983 entitled “Systems and Methods for Compact and Low-Cost Vibrational Spectroscopy Platforms” filed Mar. 30, 2021. The disclosure of U.S. Provisional Patent Application No. 63/167,983 is hereby incorporated by reference in its entirety for all purposes.

### FIELD OF THE INVENTION

The present invention generally relates to systems and methods for compact and low-cost vibrational spectroscopy platforms; and more particularly to systems and methods for compact and low-cost vibrational spectroscopy platforms enabled by improvement in image analysis and data analysis.

### BACKGROUND OF THE INVENTION

Vibrational spectroscopy, including infrared and Raman optical spectroscopy, is an important technique for fingerprinting molecular structures and the chemical compositions of different materials, with applications spanning cellular identification, food chemistry, drug quality control and explosives detection. The utility of vibrational spectroscopy stems from its ability to probe the molecular structures through optical scattering. When light interacts with a molecule, most of the incident light scatters with the same wavelength while a small fraction of the optical energy scatters at a different wavelength. This is due to the inelastic interaction between the incident light and the vibrational modes of the molecule. This phenomenon may give rise to optical signatures that are characteristic of the molecule and hence can be used for molecular identification that forms the basis for various applications. Despite its great promise, the wide adoption of vibrational spectroscopy in in-field applications has been hindered by the demanding instrumentation requirements.

### BRIEF SUMMARY OF THE INVENTION

Many embodiments are directed to systems and methods for compact and low-cost vibrational spectroscopy platforms. Several embodiments implement machine learning processes to identify optical spectral features that are most relevant for identification of elements including (but not limited to): a pathogen strain, from a set of pathogen species and strains. Examples of a pathogen include (but are not limited to): bacteria, virus, fungus, and microorganism. Some embodiments provide spectral data analysis using a subset of spectral bands, reducing from the full wide-band high-resolution spectrum. Data analysis enhancement in accordance with certain embodiments enables low-cost hardware and compact designs in vibrational spectroscopy platforms. A number of embodiments provide that the compact and low-cost vibrational spectroscopy platforms exhibit comparable accuracy in element identification when compared with conventional vibrational spectroscopies.

One embodiment of the invention includes a vibrational spectroscopy platform comprising a sample light source, an image sensor disposed a set distance from a sample, and at least one optical filter disposed in line with the image sensor. The sample light source is configured to deliver a full vibrational spectrum of the sample to the image sensor. A light from the sample light source passes through the at least one optical filter prior to reaching the image sensor, and the at least one optical filter selects a set of spectral bands from the full vibrational spectrum of the sample for detection by the image sensor such that the set distance between the image sensor and the sample is shorter than required for detection of the full vibrational spectrum.

In an additional embodiment, the vibrational spectroscopy platform is a Raman spectrometer.

In a further embodiment, the sample light source is a continuous wave laser or a pulsed laser.

In another embodiment, the image sensor comprises a pixel binning process.

In yet another embodiment, the pixel binning process is selected from the group consisting of 2-pixel binning, 4-pixel binning, 8-pixel binning, and any combinations thereof.

In an additional further embodiment, the image sensor is a CCD image sensor.

In a yet further embodiment, the image sensor comprises a hyperspectral imaging scheme.

In a further embodiment again, the at least one optical filter is integrated on the image sensor.

In another embodiment again, the at least one optical filter comprises a thin film or a dielectric metasurface.

In a further additional embodiment, the set of spectral bands comprises from 250 bands to 750 bands.

In another additional embodiment, the set of spectral bands are selected using a machine learning process on a computer.

In a yet further embodiment again, the machine learning process comprises a feature selection process selected from the group consisting of ANOVA, x², mutual information, and ant colony optimization.

A still further embodiment includes a method to identify a pathogen using a Raman spectrometer comprising:
obtaining a plurality of Raman spectra of pathogens as input;
applying a feature selection process to the plurality of Raman spectra to select a plurality of features on a computer;
classifying and ranking the plurality of features by classification accuracy;
determining a set of features based on the ranking as output; and
applying the set of features to identify the pathogen;
   where the classifying and ranking process comprises training a convolutional neural network with the plurality of features.

In a yet further embodiment, the feature selection process is selected from the group consisting of ANOVA, x², mutual information, and ant colony optimization.

In still another embodiment, the plurality of Raman spectra comprises Raman spectra from 30 bacteria.

In a still yet further embodiment, the bacteria are selected from the group consisting of Escherichia coli, Klebsiella pneumoniae, Klebsielle aerogenes, Enterobacter cloacae, Proteus mirabilis, Serratia marcescens, Pseudomonas aeruginosa, Staphylococcus aureus, Staphylococcus epidermidis, Staphylococcus lugdunensis, Streptococcus pneumoniae, Streptococcus pyogenes, Streptococcus agalactiae, Streptococcus dysgalactiae, Streptococcus sanguinis, Enterococcus faecalis, Enterococcus faecium, Salmonella enterica, Candida albicans, Candida glabrata, Mycobacterium tuberculosis, and any combinations thereof.

In an additional embodiment again, the set of features comprises from 250 features to 750 features.

In another further embodiment, the set of features comprises 300 features.

In still yet another further embodiment, the pathogen is selected from the group consisting of bacterium, virus, fungus, microorganism, yeast, circulating tumor cell, exosome, extracellular vesicle, and biomarker.

In still another further embodiment again, the plurality of features is at least ¼ of all features in a full Raman spectrum.

In another further additional embodiment, the feature selection process reduces features from the plurality of Raman spectra to at least 250 features.

In yet another further embodiment again, an identification accuracy of the pathogen using the set of features is at least 92%.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 illustrates a Raman spectrometer block diagram in accordance with prior art.

FIG. 2 illustrates a process to identify a set of features for element identification in accordance with an embodiment of the invention.

FIG. 3 illustrates a process to construct a compact and cost effective Raman spectrometer in accordance with an embodiment of the invention.

FIG. 4 illustrates a compact and cost effective vibrational spectroscopy platform in accordance with an embodiment of the invention.

FIG. 5 illustrates average of 2000 spectra for each bacterial isolate yielding 30 total Raman spectra in accordance with an embodiment of the invention.

FIG. 6 illustrates 30 bacterial and their identifying and antibiotic information in accordance with an embodiment of the invention.

FIG. 7 illustrates a 1-D CNN architecture used for the bacterial pathogen classification task in accordance with an embodiment of the invention.

FIG. 8 illustrates the algorithm for the ant colony optimization—CNN implementation in accordance with an embodiment of the invention.

FIG. 9 illustrates top 250 features selected using the x², ANOVA, and mutual information univariate statistical tests in accordance with an embodiment of the invention.

FIG. 10 illustrates the 79 significant features under the x², ANOVA, and mutual information univariate statistical tests in accordance with an embodiment of the invention.

FIG. 11 illustrates visualization of significant features obtained through ACO-CNN in accordance with an embodiment of the invention.

FIG. 12 illustrates hyperparameter optimization of feature subset size in accordance with an embodiment of the invention.

### DETAILED DESCRIPTION OF THE INVENTION

Turning now to the drawings and data, compact and low-cost vibrational spectroscopy platforms are described. Many embodiments provide enhanced imaging and data analysis in compact and low-cost vibrational spectroscopy platforms. Several embodiments incorporate enhancement in imaging technologies and data analysis to build accurate low-cost vibrational spectroscopy platforms. In some embodiments, machine learning processes can identify important optical spectral features relevant for the identification of an element including (but not limited to): a pathogen strain, an E. Coli strain, from a set of elements of other pathogen species and strains. Examples of a pathogen include (but are not limited to): bacteria, virus, fungus, microorganism, yeast, circulating tumor cell, exosome, extracellular vesicle, and biomarker. By reducing the spectral data input from the full wide-band high-resolution spectrum to subsets of spectral bands, many embodiments enable compact and low-cost hardware on spectroscopic platforms customized for specific identification tasks. Compact and low-cost vibrational spectroscopy platforms in accordance with many embodiments can facilitate in-field applications of vibrational spectroscopy that involves detection and identification of certain objects or substances. Examples of applications include (but are not limited to): point-of-care diagnostics platforms, inline quality control of food and pharmaceutical products, and security screenings. Several embodiments provide that the compact and low-cost vibrational spectroscopy platforms can be used in diagnostics labs, clinics, hospitals, food manufacturers, drugs manufacturers, and security agencies.

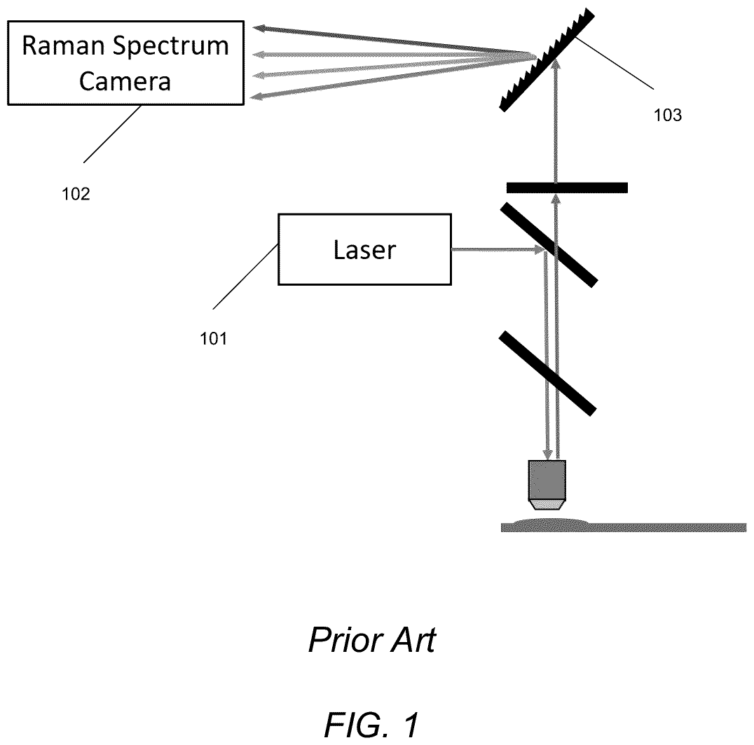

Vibrational spectroscopy typically handles weak optical signals with distinct spectral features. Measuring such signals may require sensitive and low-noise imaging sensors with high spectral resolution capabilities to achieve relevant accuracy for identification applications. This can be accomplished using high-end imaging cameras with large imaging sensor chips characterized with low-noise performance. These cameras are significantly heavier and bulkier compared to regular cameras used in machine-vision applications and cost about 10 to 100 times more. Additionally, to meet the high spectral resolution requirements, the design of the overall imaging system should provide long optical path between a diffractive optical element and the imaging sensor to allow light to sufficiently disperse spatially before reaching the sensor. This can result in costly and bulky tools with large footprints. A block diagram of Raman spectrometer is illustrated in FIG. 1. Lasers (101) can be used as excitation sources to provide high power in a tightly focused spot. Detectors and/or imaging sensors (102) can be used to detect the signal. A long optical path between a diffractive optical element (103) and the imaging sensor can allow light to sufficiently disperse spatially before reaching the sensor. The imaging sensors (102) can be costly due to high resolution requirements. A long optical pathway between the diffractive optimal element (103) and the imaging sensor (102) can make the spectrometer bulky.

Even though compact platforms exist, they lack the resolution requirements and/or the high noise performance that can attain relevant limit of detection specially for miniature material volumes. The existing compact platforms remain pricy with a price mark of about ten thousand dollars. Driven by machine vision applications, low-cost high-performance cameras have been developed with great improvements in their noise performance and sensitivity especially at longer wavelengths. In addition, the growing capability of data analysis led by the adoption of machine-learning algorithms have transformed many technologies including speech and image recognition and medical diagnosis.

Many embodiments provide compact and low-cost vibrational spectroscopy platforms for element identification. Several embodiments provide that improved data analysis processes enable compact and low-cost designs in vibrational spectroscopy platforms. Vibrational spectroscopy-based identification can rely on two elements: 1) a reference library of the spectral signatures of the targeted elements and 2) a reliable algorithm to contrast a measured spectrum against this library and accurately identify it accordingly. A vibrational spectrum is normally measured over a range of wavelengths that can be longer or shorter than a certain excitation wavelength and can be characterized by spectral peaks. The pattern of those peaks including (but not limited to): wavelength, height, width, and relative heights, can represent the unique fingerprints of the target element. For applications such as bacterial identification, the differences between the spectral fingerprints of various species can be quite subtle. Thus, high spectral resolution and high signal-to-noise ratio signals can be beneficial for accurate identification. Machine learning processes can achieve high accuracy in Raman-based identification of bacteria with low signal-to-noise ratio data. (See, e.g., Ho, C. S., et al., Nature Communications, 10, 4927, (2019); the disclosure of which is incorporated herein by reference.) Many embodiments incorporate machine learning and/or deep learning processes to determine the relevant features and spectral bands that may be necessary for accurate element identification. Several embodiments provide that not all spectral features have the same weight in the identification process and only subsets of them may be needed for accurate element identification. By specifying these bands of interest, certain embodiments enable to reduce the spectral resolution of the measured spectrum and consequently use a compact cost-effective spectrometer design without compromising the identification accuracy.

The reduction of the spectral resolution in spectral data analysis processes in accordance with many embodiments enables compact and low-cost spectrometer designs. Several embodiments provide that the reduction in the spectral resolution requirements facilitate more compact designs. In some embodiments, dispersed light may need to propagate only for a short distance before reaching the sensor which can reduce the physical footprint of the device. Certain embodiments provide that each pixel on the imaging sensor may receive a larger number of photons which can improve the signal to noise ratio and allow for the use of cheaper cameras without compromising the performance.

Several embodiments provide imaging hardware of improved performance and lower cost by specifying particular sets of spectral bands of relevance. Some embodiments combine adjacent pixels on the imaging sensor, known as pixel binning, based on the relevant spectral bands. For CCD imaging sensors, pixel binning in accordance with certain embodiments can improve the signal-to-noise ratio by reducing the readout noise and by allowing for shorter exposure time. A number of embodiments implement a hyperspectral imaging scheme. In such embodiments, optical filters designed to match the specific spectral bands selected for accurate element identification can be integrated on the imaging sensor and/or various regions on the imaging sensor. The optical filters in accordance with certain embodiments can detect at least one of these specified bands. Several embodiments provide that the optical filters can be implemented with technologies including (but not limited to): thin-films and/or dielectric metasurfaces. One advantage of implementing optical filters in accordance with many embodiments is ultra-compact designs, where the optical filters requires no dispersive elements and can be performed with just a camera and light collection optics.

Many embodiments apply feature selection processes to Raman-based bacterial identification platforms. Several embodiments use the Raman spectrum library built for about 30 common bacterial strains. Some embodiments apply filter feature selection processes as well as ant colony optimization processes to extract the relevant spectral bands and features. Out of the total 1000 spectral wavelengths recorded, certain embodiments identify the top 250 features that can be used in the classification processes. In certain embodiments, these relevant features extracted by each approach show significant overlaps. Using these subsets of features that are localized within certain spectral bands, many embodiments are able to achieve similar classification accuracy compared to that when the full set of features is used. In a number of embodiments, a subset of 250 features produce classification accuracy of at least about 92%. In certain embodiments, a subset of 250 features produce classification accuracy at the antibiotic level of at least about 84%. By identifying those bands, a number of embodiments make it possible to redesign the spectrometer with a reduced footprint and configure the pixel binning of the imaging sensor accordingly to provide better noise performance at the bands of interest.

Several embodiments provide the pixel-binning processes using the bacterial identification platforms with the same library. In some embodiments, the pixel-binning can be done by using software after the data has been collected. Consequently, the added advantage of improving the signal-to-noise ratio with pixel binning may not be achieved. Hence, the resolution is reduced without improving the signal-to-noise ratio. The results in accordance with certain embodiments may represent a lower boundary for the system performances. The classification accuracy with pixel binning approaches when the binning is done at the hardware level with improved signal-to-noise ratio can be better. Several embodiments provide retraining the machine learning classifier after applying three different pixel-binning: 2 pixels, 4 pixels, and 8 pixels. In some embodiments, the classification accuracy can be at least about 92%. The classification accuracy may drop by about 5% with the 8 pixel-binning approach.

### Pathogen Identification with Raman Spectroscopy

Raman optical spectroscopy of bacteria yields information-rich molecular fingerprints that may be used in culture-free identification and antibiotic susceptibility testing. Accurate identification may require high-quality data collected with expensive and sophisticated optical equipment that may not be adopted for cost-effective point-of-care platforms. Many embodiments provide methods and systems for incorporating more simplified hardware in vibrational spectroscopy platforms by virtue of feature selection. Instead of using the full spectral data of pathogens, several embodiments apply filter and wrapper feature selection processes to isolate the subsets of relevant and discriminative features from the original Raman spectra. Several embodiments use a feature subset about ¼ the size of the original full-spectra, and are able to classify the antibiotic treatment identification for about 30 common bacterial pathogens with at least about 92% accuracy, compared to 97% with the full features. Some embodiments can use a subset of less than ¼ the size of the original full-spectra. Certain embodiments can use a subset of greater than ¼ the size of the original full-spectra. Simplification in the spectral space in accordance with certain embodiments enables more compact and low-cost hardware designs. Moreover, those selected features may help tie the biological and molecular origins of the spectral regions to distinct bacterial isolates.

Bacterial are responsible for an overwhelming number of deadly infections. At the same time, bacterial infections can be difficult and costly to diagnose and treat. Pathogen identification and antibiotic susceptibility testing typically involve culturing, a slow process that may span several days. In addition to the health risks and the economic burden, such slow processes may promote the misuse of antibiotics—a major contributor to the alarming increase in antibiotic resistance. Devising ways to circumvent the process of time consuming pathogen identification can mitigate the prescription of general antibiotics, thereby lessening pathogen antimicrobial resistance.

Raman spectroscopy is one of the promising techniques for pathogen identification. Raman scattering refers to the inelastic photon scattering that excites and probe the vibrational modes of a molecule. As such, each molecular structure gives rise to a unique Raman signature that can be used for molecular identification. Due to the distinct molecular composition of different pathogens, each pathogen has a unique Raman fingerprint. Previous studies have shown that combining deep learning with Raman spectroscopy enables accurate pathogen identification and antibiotic treatment for 30 common pathogens even with low signal-to-noise ratio (SNR) signals. (See, e.g., Ho, C. S., et al., Nature Communications, 10, 4927, (2019); the disclosure of which is incorporated herein by reference.) Nevertheless, accurate identification would benefit from signals with high spectral resolution mandating the use of bulky and costly hardware. Many embodiments provide simplified hardware designs by determining the key spectral features that can be utilized by the classifier to identify the pathogens. By specifying those key spectral domains and features, several embodiments provide designs of a customized hardware with less demanding requirements on the resolution or signal quality. However, classifiers that employ convolutional neural networks or other deep-learning processes may be a black box with no information about the inner handling of the data including the details about the important features that are most relevant.

Several approaches have been introduced to detangle the innerworkings of neural networks and determine the significance of spectral features in Raman classification problems. For example, Efitorov et. al. focused on the classification and identification of mixtures of inorganic salts given their Raman spectra. (See, e.g., Efitorov A., et al., Procedia Computer Science, 66, 93-102, (2015); the disclosure of which is incorporated herein by reference.) As such, multi-component ionic compositions of up to 10 ions are created and their Raman spectra are obtained. A 5 layer neural network was used for identifying the components and four distinct methods were applied to select the most significant features from the original spectra. The significance of the selected features was then assessed by running the neural network model using only the subset of features and evaluating the accuracy relative to the original model. The feature selection methods utilized are:
Standard Deviation: the standard deviation of each feature is evaluated. Features with the greatest standard deviation are assumed to be most significant.
Cross Correlation: the correlation of each of the features with the output classification is evaluated. The features that are most correlated with the output are considered significant.
Cross Entropy: the cross entropy between each feature and the output class is evaluated and the features with the greatest cross entropy are deemed to be significant.
Weight Analysis Dimensionality Reduction: The weights of the neural network are used to evaluate feature significance. Features in the input channel that have greater relative weight assigned to them in the parameters are deemed more significant.
   Of these techniques, Weight Analysis Dimensionality Reduction performed best for the task. However, since the model used comprised a 5 layer network, these techniques that analyze the model weights and gradients may not perform as effectively in applications with a convolutional neural network.

Another feature selection approach has been reported by Li et. al. and aimed to pinpoint five bands in Raman spectra that are most discriminative when classifying colorectal cancer. (See, e.g., Li, S., et al., Optics Express, 22, 21, 25895-25908, (2014); the disclosure of which is incorporated herein by reference.) This work employed a Support Vector Machine (SVM) model for classification combined with the technique of Ant Colony Optimization (ACO) for feature selection. Ant Colony Optimization Band Selection is a technique that selects the optimal subset of features for a classification task through repeatedly subsampling and evaluating distinct collections of features. Li et. al additionally presented direct links between Raman peaks and molecular and cellular alterations associated with malignant transformations that are ascertained through a deeper analysis of the selected significant feature regions by biology and medical experts. While integration of the ACO technique with SVMs and standard neural networks exists, no integration of this technique has been done with complex convolutional neural networks. An alternative approach to apply ACO can be through unsupervised feature extraction methods as has been analyzed by Tabakhi et. al. (See, e.g., Tabakhi S., et al., Engineering Applications of Artificial Intelligence, 32, 112-123, (2014); the disclosure of which is incorporated herein by reference.) Tabakhi et al. showed that an unsupervised implementation of ACO that can be effectively coupled with any classification technique. Their implementation of ACO can learn subsets of features with minimal intra-subset correlation, optimal for tasks with multiple highly correlated features.

### Pathogen Identification with Subsets of Raman Spectra

Accurate pathogen identification with Raman spectrometers may require high-quality data collected with expensive and sophisticated optical equipment that may not be adopted for cost-effective point-of-care platforms. Many embodiments provide methods and systems for incorporating more simplified hardware in vibrational spectroscopy platforms by virtue of feature selection. Instead of using the full spectral data of pathogens, several embodiments apply filter selection and/or wrapper feature selection processes to isolate the subsets of relevant and discriminative features from the original Raman spectra. Several embodiments use a feature subset about ¼ the size of the original full-spectra, and are able to classify the antibiotic treatment identification for about 30 common bacterial pathogens with at least about 92% accuracy, compared to 97% with the full features. Simplification in the spectral space in accordance with certain embodiments enables more compact and low-cost hardware designs. Moreover, those selected features may help tie the biological and molecular origins of the spectral regions to distinct bacterial isolates.

Many embodiments provide feature selection processes with pathogen Raman spectra signatures. Several embodiments utilize a Raman library previously built for 31 bacterial pathogens. A trained 1-D convolutional neural network (CNN) on more than 60,000 pathogen Raman spectra collected for the 31 pathogens shows that classification accuracy based on the antibiotic treatment group exceeds 97%. Some embodiments utilize the CNN model as a baseline and integrate feature selection processes. The feature selection processes in accordance with certain embodiments can specifically identify the spectral regions and features that are more relevant for the classification problem. A number of embodiments implement univariate feature selection processes including (but not limited to): ANOVA, x², mutual information, and unsupervised ACO for feature selection. Using the top features obtained by these various methods, several embodiments provide the classification accuracy using the reduced spectral space and analyze the overlap between the features selected by these processes. Many embodiments provide that reducing the feature space does not reduce the classification accuracy proportionally. Moreover, considerable overlap between the important feature obtained by various methods in accordance with some embodiments can be observed. Many embodiments provide that by integrating feature selection and deep learning processes in Raman spectroscopy, a more simplified hardware design as well as a significant reduction in the computational cost can be achieved. Several embodiments provide a better understanding of the biological and molecular origins of the pathogen Raman signatures. This in turn would allow for the extraction of more sophisticated information about the underlying pathogen molecular compositing solely from the optical signatures without the demanding genetic or proteomic analysis.

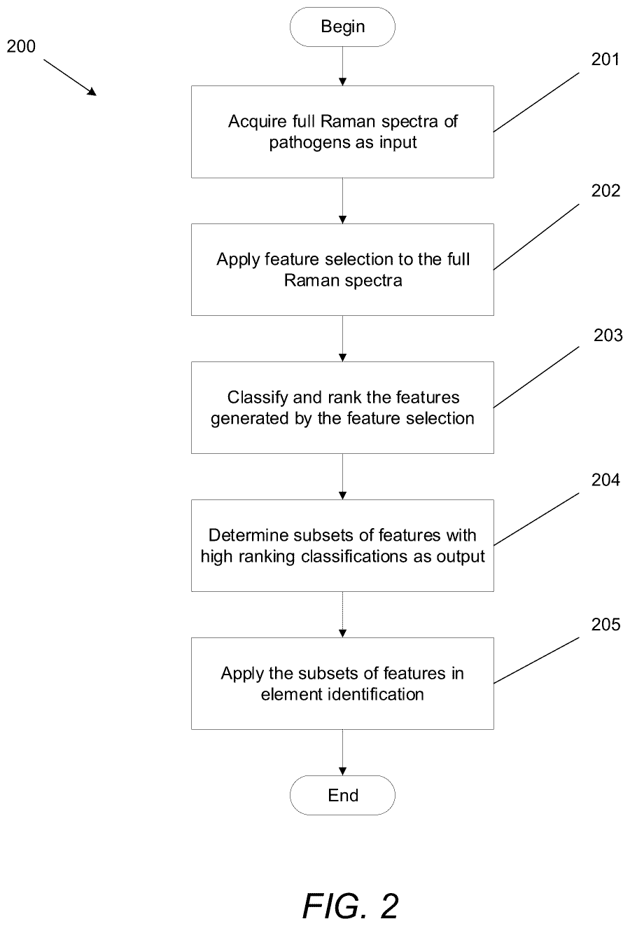

A process to determine subsets of Raman spectra features for pathogen identification in accordance with an embodiment of the invention is illustrated in FIG. 2. The process 200 can begin by obtaining full Raman spectra of pathogens as input (201). Some embodiments include input datasets that include full Raman spectra of bacteria and yeasts. In a number of embodiments, input datasets can include full Raman spectra of 30 common bacterial pathogens. Examples of bacteria strains include (but are not limited to) Escherichia coli, Klebsiella pneumoniae, Klebsielle aerogenes, Enterobacter cloacae, Proteus mirabilis, Serratia marcescens, Pseudomonas aeruginosa, Staphylococcus aureus, Staphylococcus epidermidis, Staphylococcus lugdunensis, Streptococcus pneumoniae, Streptococcus pyogenes, Streptococcus agalactiae, Streptococcus dysgalactiae, Streptococcus sanguinis, Enterococcus faecalis, Enterococcus faecium, Salmonella enterica, Candida albicans, Candida glabrata, and Mycobacterium tuberculosis. As can readily be appreciated, any of a variety of full Raman spectra can be utilized as appropriate to the requirements of specific applications in accordance with various embodiments of the invention.

Feature selection processes can be applied to the full Raman spectra to isolate the subsets of relevant and discriminative features (202). Many embodiments enable Raman-based pathogen identification processes to be more efficient by simplifying the spectral feature space necessary for accurate classification. Convolutional neural network classifiers typically do not provide information about the key attributes necessary for the identification task. Several embodiments apply different feature selection methods and extract these features that are necessary for the accurate identification using a computer. Applying filter and/or wrapper feature selection processes in accordance with some embodiments yield an interpretable subset of features that are discriminative and significant in bacterial pathogen classification. Some embodiments utilize the CNN model as a baseline and integrate feature selection processes. Several embodiments include univariate feature selection processes including (but not limited to): ANOVA, x², mutual information, and unsupervised ACO for feature selection. As can readily be appreciated, any of a variety of feature selection process can be utilized as appropriate to the requirements of specific applications in accordance with various embodiments of the invention. Certain embodiments include applying the univariate feature selection techniques to input Raman spectra and selecting the corresponding top features using each approach. Some embodiments select from about 250 to about 1000 features. As can readily be appreciated, any of a variety of feature numbers can be utilized as appropriate to the requirements of specific applications in accordance with various embodiments of the invention.

The selected features can be classified and ranked (203). Various approaches can be applied to analyze the selected features from feature selection. Some embodiments reduce the feature space through averaging consecutive features. Such embodiments can simulate Raman spectra readings that have lower resolution and will be useful in determining model accuracy with consolidated inputs. Several embodiments include applying the univariate feature selection processes to full Raman spectra and selecting the corresponding top at least 250 features. In certain embodiments, CNN models can be trained using the subsets of at least 250 features from univariate feature selection and evaluate their accuracies on the test set along with depicting the regions of importance visually on the input spectra. A number of embodiments implement ant colony optimization tied with the convolutional neural network model and find the at least 250 most discriminative features for classification. Relative to the accuracy of 97% using all original spectral features in classification, a subset of about 250 features produce classification accuracy of at least about 92% in accordance with certain embodiments.

The subsets of features can be determined as output (204). Some embodiments provide ablative analysis to tune the hyperparameter of feature subset size to find the number of features that would be best for feature selection on Raman spectra. Different subset sizes from about 50 to about 1000 of the selected features can be tested. By identifying these subsets of features that are sufficient for accurate classification, several embodiments reduce the computational cost associated with the classification task.

The selected subsets of features from the full Raman spectra can be applied to identify unknown elements including (but not limited to) pathogens (205). Many embodiments reduce the required resolution of Raman spectra to identify elements. Some embodiments enable more compact and cost effective optical spectroscopy hardware where only specific spectral bands need to be collected with sufficient resolution. A number of embodiments are able to identify the biological origins of the relevant and most significant features and utilize this to determine different important characteristics of the pathogen such as the presence of an antibiotic resistance gene among several other interesting clues that may be challenging to identify and may require advanced genetic or proteomic studies.

While various processes for identifying subsets of features for pathogen identification are described above with reference to FIG. 2, any of a variety of processes that utilize feature selection and deep learning to select features from Raman spectra can be utilized in the identification of subsets of features for pathogen identification as appropriate to the requirements of specific applications in accordance with various embodiments of the invention.

### Compact and Low-Cost Vibrational Microscopy Platforms

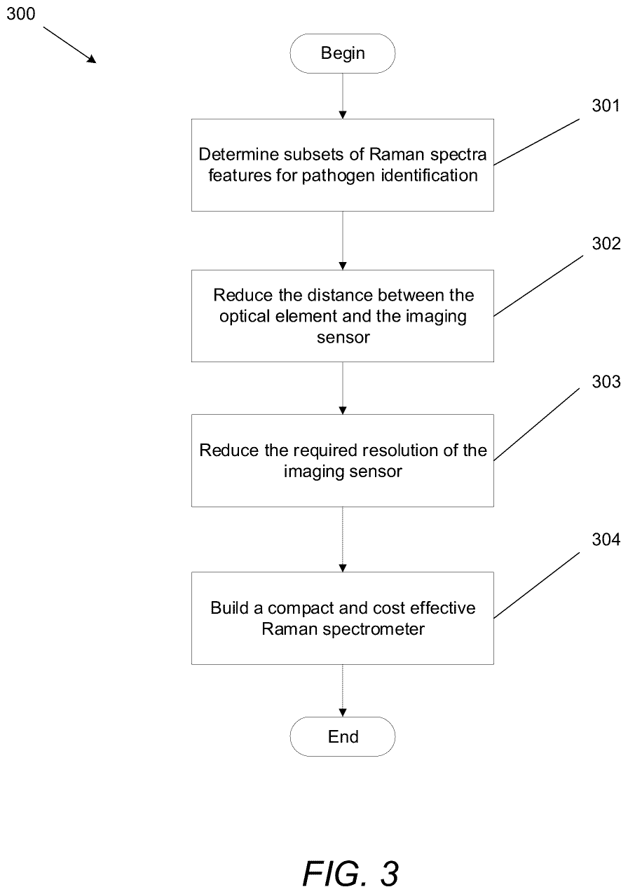

Many embodiments provide compact and cost effective Raman spectrometers due to the reduction of spectra features for pathogen identification. A process to build a compact and cost effective Raman spectrometer in accordance with an embodiment of the invention is illustrated in FIG. 3. The process 300 can begin by determining subset features of Raman spectra for element and/or pathogen identification (301). By determining subset features of Raman spectra, only specific spectral bands need to be collected with sufficient resolution for pathogen identification. In some embodiments, about 250 to 300 features, about 250 to 700 features, about 250 to 1000 features from Raman spectra may be collected to identify pathogens. By determining subsets of Raman spectra features, certain embodiments reduce the spectral resolution of the measured spectrum and consequently use a compact cost-effective spectrometer design without compromising the identification accuracy.

The distance between the optical element and the imaging sensor can be reduced for Raman spectrometers (302). The reduction in the spectral resolution requirements facilitate more compact designs. In some embodiments, dispersed light may need to propagate only for a short distance before reaching the sensor which can reduce the physical footprint of the device. The resolution of imaging sensors of spectrometers can be lowered (303). Certain embodiments provide that each pixel on the imaging sensor may receive a larger number of photons which can improve the signal to noise ratio and allow for the use of cheaper cameras without compromising the performance. With the improved design, a compact and cost effective Raman spectrometer can be built (304).

Many embodiments provide compact and low-cost vibrational microscopy platforms. The vibrational microscopy platforms in accordance with several embodiments implement a subset of a full spectral bands that are normally required by a traditional vibrational microscopy. In some embodiments, the vibrational spectroscopy platforms including (but not limited to) Raman spectrometers include a sample light source, an image sensor disposed a set distance from a sample, and at least one optical filter disposed in line with the image sensor. Certain embodiments provide that the sample light source can deliver a full vibrational spectrum of the sample to the image sensor. In a number of embodiments, the light from the sample light source passes through the at least one optical filter prior to reaching the image sensor. The at least one optical filter in accordance with many embodiments can select a set of spectral bands from the full vibrational spectrum of the sample for detection by the image sensor. In several embodiments, the set distance between the image sensor and the sample can be shorter than required for detection of the full vibrational spectrum.

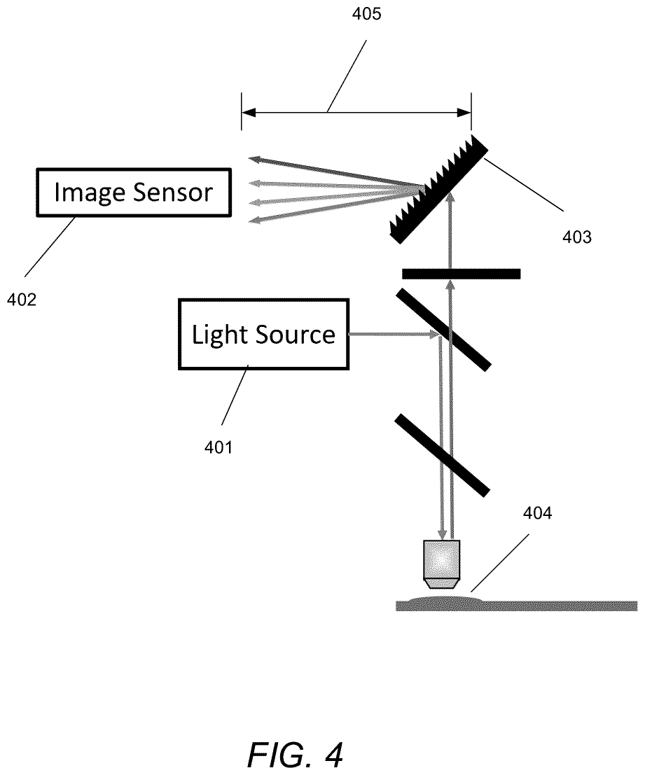

A diagram of the compact and low-cost vibrational microscopy platform in accordance with an embodiment of the invention is illustrated in FIG. 4. A light source including (but not limited to) a continuous wave laser or a pulsed laser (401) can provide high power in a tightly focused spot and deliver a full vibrational spectrum of the sample (404). Image sensors (402) and optical filters (403) can be disposed in line with each other with a distance (405). The light from the sample light source (401) can pass through the optical filters (403) prior to reaching the image sensor (402). The optical filters can select a subset of spectral bands from the full vibrational spectrum for detection. By reducing the spectral bands that need to be detected, the distance (405) between the image sensor and the optical filters can be reduced to build a compact vibrational microscopy platform. The resolution of image sensors can also be lowered to contribute to a low-cost vibrational microscopy platform.

While various processes and systems for compact and cost effective vibrational microscopy platforms are described above with reference to FIG. 3 and FIG. 4, any of a variety of processes and systems that utilize subsets of full vibrational spectra features to reduce imaging resolution can be utilized in the design and fabrication of a compact spectrometer as appropriate to the requirements of specific applications in accordance with various embodiments of the invention.

### EXEMPLARY EMBODIMENTS

Although specific embodiments of methods, systems and apparatuses are discussed in the following sections it will be understood that these embodiments are provided as exemplary and are not intended to be limiting.

### Example 1: Bacteria Pathogen Raman Spectra Library

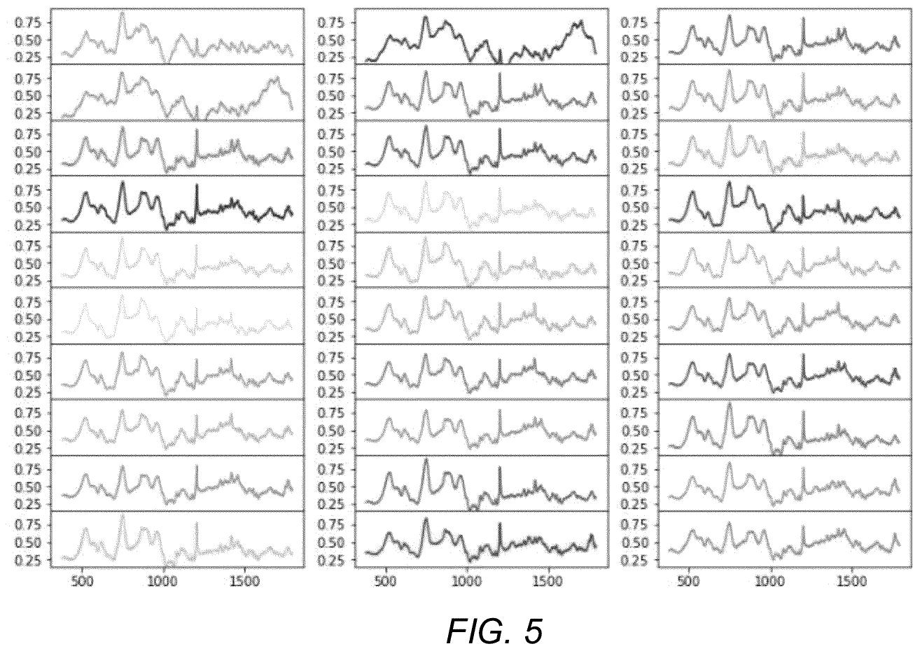

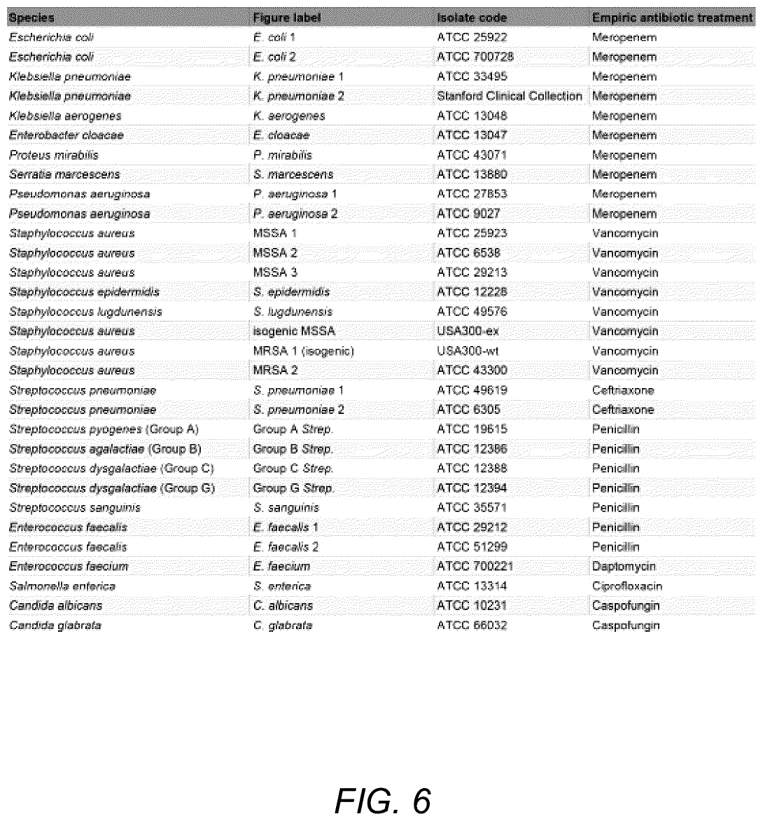

Many embodiments implement the pathogen Raman-signature library for 31 bacterial infection. The raw dataset is composed of 62,000 Raman spectra with 2,000 spectra for each of 31 bacterial and yeast isolates. Two of these isolates are isogenic strains with only one gene different making the classification problem between these two strains particularly challenging. Each Raman signature in this dataset spans a spectral range from about 381.98 cm⁻¹ to about 1792.4 cm⁻¹ with a resolution of about 1.41 cm-1 resulting in 1000 intensity readings for each of the spectra. The average spectra for each pathogen in accordance with an embodiment is shown in FIG. 5. The 30 spectra shown in FIG. 5 represent average of all 2000 spectra for each bacterial isolate. The 30 bacterial isolates and their identifying and antibiotic information are displayed in order by column in FIG. 6.

To identify the important spectral features necessary for accurate identification, several embodiments apply four feature selection approaches. The first three approaches include filter feature selection techniques. In some embodiments, the features are treated independently and are ranked based off some discriminative score in a manner decoupled from the classification task at hand. The fourth approach is based on Ant

Colony Optimization, and known as a wrapper feature selection method that ties directly with the classification method. To assess the effectiveness of a subset of features in classification, some embodiments apply a 1-D convolutional neural network (CNN) to classify the 30 bacterial pathogens. The subsets of features that yield the highest classification accuracy can be deemed to be a most significant and discriminative. Some embodiments implement the CNN model that use all 1000 input features of the Raman spectra. Several embodiments find feature subsets of size about 250. A number of embodiments exhibit a four-fold decrease in the number of features in the input space. This hyperparameter can be optimized in the ablative analysis.

### Example 2: CNN Architecture

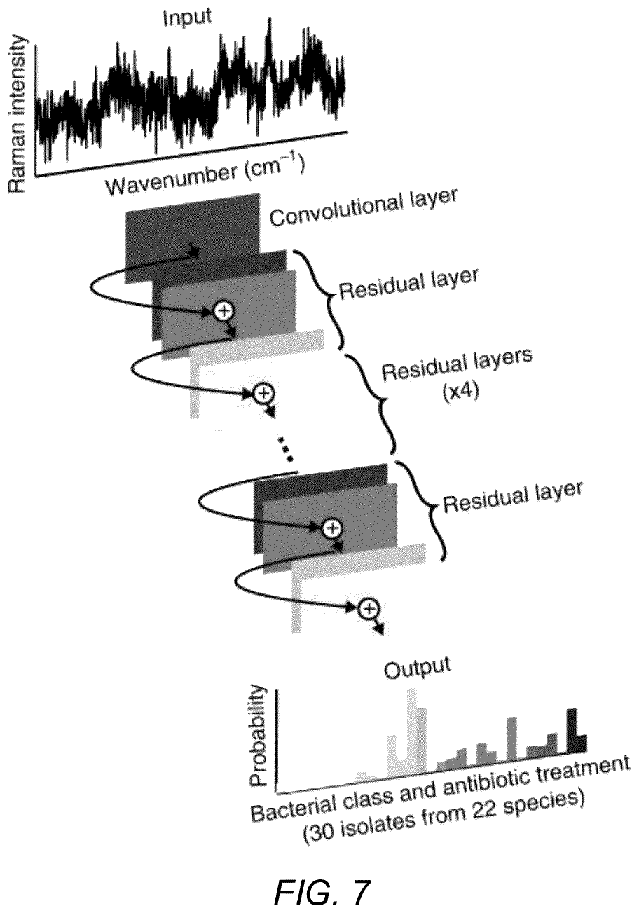

The baseline CNN model is adapted from a resnet architecture composed of an initial convolutional layer with 64 filters, six residual layers, and one fully connected layer. 1-D CNN architecture used for the bacterial pathogen classification task in accordance with an embodiment is illustrated in FIG. 7. The Raman spectra readings can be fed as input to the model with output being one of the 30 possible bacterial classifications. Each residual layer is composed of four convolutional layers and each residual layer is with 100 filters. Skip connections between the first and last layer of each residual layer are added to mitigate vanishing gradients that are initially encountered in training and thereby allow for better gradient flow overall. An Adam optimizer can be used with a learning rate of 0.001 and beta values of 0.5 and 0.999. This β1 is selected over the default of 0.9 due to its improvement of the training procedure for the classification task using all 1000 Raman spectral features. Although it is more computationally costly, certain embodiments run the model using 5-fold cross validation. Given that this task may have significant clinical implications, several embodiments provide robust evaluation. After separating 10% of the data as the test split, the remaining data is dividing into five folds. One of these folds is selected as the validation set and the remaining four folds act as the training set. Some embodiments train the model on each of the distinct validation folds and thereafter predict the model's accuracy on the test set.

### Example 3: Filter Feature Selection—x² Test

Filter feature selection approaches treat classification and selection of features as decoupled tasks. These approaches identify significant features through analyzing inherent properties of the data. Many embodiments use univariate feature selection processes that assume independence of the input features and measure feature significance through different evaluation criteria. Several embodiments implement three univariate feature selection processes including x², ANOVA, and mutual information.

The x² test effectively measures the dependence between stochastic variables. Several embodiments evaluate the x² statistic for each of the 1000 original spectral features and select the 250 with the highest value since they are more likely to be relevant for pathogen classification. For k classes, n samples, and pᵢ probability of belonging to class i, the x² distribution is given by:

$${χ}^{2} = {\sum }_{i = 1}^{k} ( \frac{{( {x}_{i} - {np}_{i} )}^{2}}{{np}_{i}} )$$

### Example 4: Filter Feature Selection—ANOVA Test

The ANOVA test assesses if there is significant difference in a spectral feature among the 30 different bacterial classes. Several embodiments show the 250 features with the greatest F-score after calculating the statistic for each of the 1000 features. For Var_{b} as the variance between different classes and Var_{w} as the variance within a class, the F value is given by:

$$F = \frac{{Var}_{b}}{{Var}_{w}}$$

### Example 5: Filter Feature Selection—Mutual Information

Mutual information effectively serves as a measurement of the mutual dependence of the bacterial classes on the spectral features. It can be defined as the KL divergence between the joint distribution and the product of the marginals:

I(X;Y)=KL(P_{X,Y}∥Pₓ⊗P_{Y})

I(X;Y)≤I(X;X)=H(X), where H(X) is the entropy of X. Mutual information thus effectively measures the dependency between variables in a manner that the most significant features can be assessed with the highest scores. Some embodiments estimate mutual information using entropy estimation from the k-nearest-neighbors to a particular spectral feature.

### Example 6: Ant Colony Optimization

Ant Colony Optimization is based on the behavior of ants, in which they co-operatively work to find optimal travel paths through substances known as pheromones. In essence, ants deposit the chemical substances of pheromones to communicate with one another that inherently dissipates over time. The intensity of the pheromones in a location signifies to ants the importance or utility of a particular path. Ants tend to follow paths with a greater concentration of pheromones. With regards to feature selection, ants can be assigned to different sub-sets of features and pheromone concentrations are updated based on the significance of a feature subset according to classification accuracy.

Many embodiments utilize an ant colony optimization protocol to select optimal features with the use of a CNN model and selection of slightly different ACO hyperparameters for the β value described below. To perform ant colony optimization, these steps below can be looped through:
Generate artificial ants and assign some subset of features to each of the ants. Features are originally probabilistically assigned based on what is know as the global pheromone trail.
Evaluate the utility and significance of the ants and their component features.
Update the global pheromone trail based on the significance evaluation results.

Each artificial ant is assigned to a distinct subset of features from the spectra, determined through the transition probability function below for each spectral feature i:

$${p}_{i} ( t ) = \frac{{( {τ}_{i} ( t ) )}^{α} {η}_{i}^{β}}{{\sum }_{i} {( {τ}_{i} ( t ) )}^{α} {η}_{i}^{β}}$$

in which α and β are weighting factors, πᵢ(t) represents the pheromone trail magnitude at time t for the feature i and ηᵢ represents the local information of feature i. After exploring β values in the range (0.8, 1.0), some embodiments utilize a value of 1 due to its greatest performance in selecting an optimal subset of features.

The value of τᵢ(0)=1 for all features and pheromone is updated with:

τᵢ(t+1)=ρτᵢ(t)+∇τᵢ(t)

in which ρ is a constant between 0 and 1 and ∇τᵢ(t) is related to the classification accuracy of artificial ants.

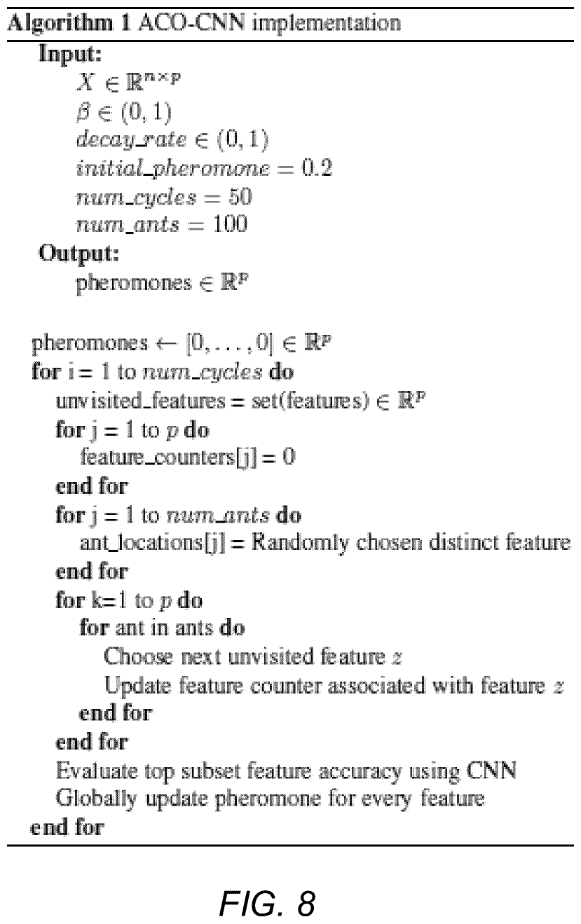

These steps are repeated until convergence to find the optimal subset of features. In essence ACO is efficiently finding a subset of features that has minimal similarity and correlation among them. As such, the ants are assigned in a fashion that best minimizes the cosine similarity between the current group of features and any additional added feature. Algorithm in accordance with an embodiment shown in FIG. 8 depicts the pseudocode for the ACO-CNN implementation.

### Example 7: Average Consecutive Features Results

Several embodiments perform five distinct experiments in line with the filter feature selection approaches and the convolutional model above. The first approach attempts to reduce the feature space through averaging consecutive features. In doing so, this simulates Raman spectra readings that have lower resolution and will be useful in determining model accuracy with such consolidated input. The next three approaches include applying the univariate feature selection techniques of ANOVA, x², and mutual information to input Raman spectra and selecting the corresponding top 250 features using each approach. Thereafter, some embodiments train the CNN model three distinct times using the 3 different subsets of 250 features and evaluate their accuracies on the test set along with depicting the regions of importance visually on the input spectra. The final model consists of implementing ant colony optimization tied with the convolutional neural network model in accordance with several embodiments and finding the 250 most discriminative features for classification. Certain embodiments perform some ablative analysis to tune the hyperparameter of feature subset size to find which number of features instead of 250 would be best to be used for feature selection on Raman spectra.

Since consecutive features in Raman data tend to be highly correlated, averaging them to yield more compact spectral space is computationally appealing. At the hardware level is equivalent to reducing spectral resolution through pixel binning. In many embodiments, pixel binning at the hardware level improves signal-to-noise ratio (SNR). Three variations of averaging consecutive features are performed. Several embodiments average each 2, 4, and 8 consecutive features to yield feature spaces of size 500, 250, and 125 respectively from the original 1000 features. These new input features are fed into the convolutional neural network model in accordance with embodiments after modifying the dimension of the input feature space it takes. The model is run 5 times for each of the averaged feature inputs and averaged to produce the results shown in Table 1.

TABLE 1
Average isolate and antibiotic level classification accuracies

| | | 2- | 4- | 8- |
|---|---|---|---|---|
| | Original | Averaged | Averaged | Averaged |
| Isolate Level Accuracy | 82.2% | 81.4% | 80.7% | 80.0% |
| Antibiotic Level Accuracy | 97.0% | 92.5% | 92.7% | 91.7% |

The original 1000 features exhibit classification accuracy at the isolate level of about 82.2% and at the antibiotic level of about 97%. Reduced feature space with 2 pixel binning has classification accuracy at the isolate level of about 81.4% and at the antibiotic level of about 92.5%. Reduced feature space with 4 pixel binning shows classification accuracy at the isolate level of about 80.7% and at the antibiotic level of about 92.7%. Reduced feature space with 8 pixel binning exhibits classification accuracy at the isolate level of about 80% and at the antibiotic level of about 91.7%. At 8-pixel binning, the accuracy drops by less than 3% at the isolate level and drops about 5% at the antibiotic level.

### Example 8: Filter Feature Selection Results

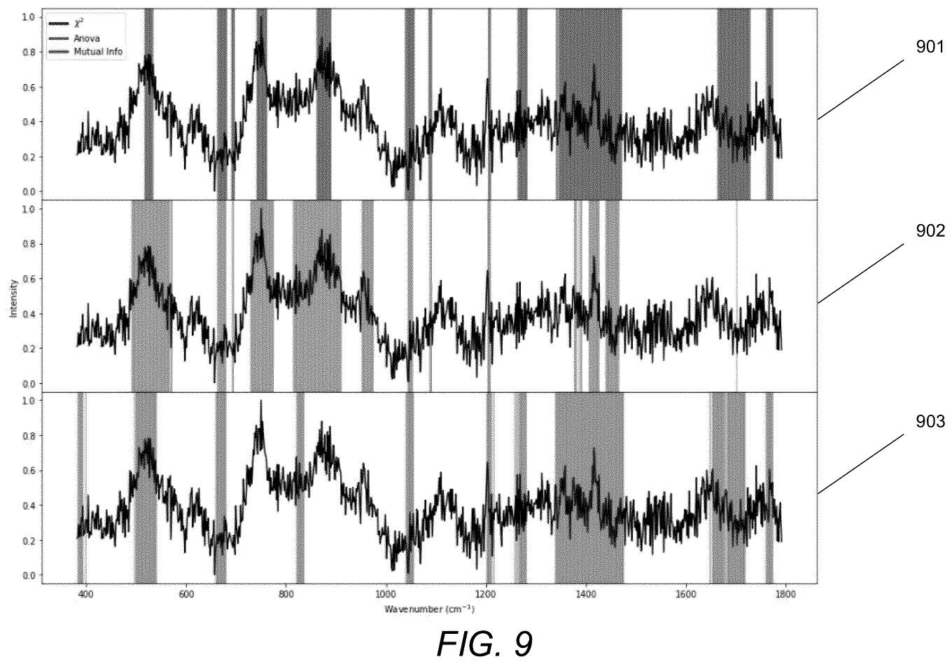

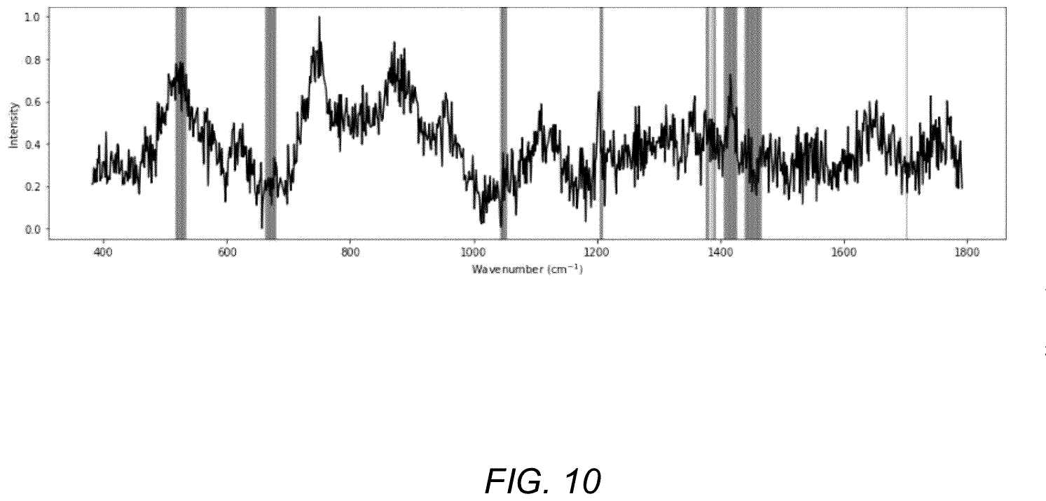

Features of the input spectra can be ranked based off their scores from the statistical techniques of ANOVA, x², and mutual information in accordance with many embodiments. Univariant significant features of each feature selection method in accordance with an embodiment is illustrated in FIG. 9. FIG. 9 shows 250 most important features using feature selection approach of x² (901), ANOVA (902), and mutual information (903). Univariant common significant features in accordance with an embodiment is illustrated in FIG. 10. FIG. 10 shows a total of 79 features that are significant among the ANOVA, x², and mutual information univariate statistical tests.

With these subsets of selected features, several embodiments run the CNN model to evaluate their classification accuracies. The classification accuracies using the original input space along with the subsets of 250 significant features from each of the above univariate statistical test approaches are shown in Table 2.

TABLE 2
Model accuracy using all 1000 input features compared
to using selected subsets of input features through
differing univariant and wrapper approaches.

| | | | Chi- | Mutual | Ant Colony |
|---|---|---|---|---|---|
| | Original | Anova | Squared | Information | Optimization |
| Isolate | 82.2% | 67.5% | 65.1% | 67.2% | 66.8% |
| Level | | | | | |
| Accuracy | | | | | |
| Antibiotic | 97.0% | 86.6% | 84.3% | 87.1% | 85.7% |
| Level | | | | | |
| Accuracy | | | | | |

The original 1000 features exhibit classification accuracy at the isolate level of about 82.2% and at the antibiotic level of about 97%. Selected feature space with ANOVA univariate statistical test has classification accuracy at the isolate level of about 67.5% and at the antibiotic level of about 86.6%. Selected feature space with x² test shows classification accuracy at the isolate level of about 65.1% and at the antibiotic level of about 84.3%. Selected feature space with mutual information test exhibits classification accuracy at the isolate level of about 67.2% and at the antibiotic level of about 87.1%. Selected feature space with ant colony optimization test exhibits classification accuracy at the isolate level of about 66.8% and at the antibiotic level of about 85.7%.

Among these univariate approaches, the ANOVA tests and the correlating subset of significant features produce the best results in retaining classification accuracy. To further analyze the results produced when using the ANOVA features, some embodiments use a confusion matrix to better assess the classification. A confusion matrix can be created for the results from the baseline model that uses all 1000 Raman spectral features and from the refined model that uses 250 of the most significant features as selected with ANOVA. A close analysis reveals that most misclassifications may occur between the strains spanning from E. coli. to S. marcescens in the matrix. In certain embodiments, same antibiotic is utilized against these strains. Several embodiments are able to classify the group of isolates from others at the antibiotic level.

### Example 9: Ant Colony Optimization Feature Selection Results

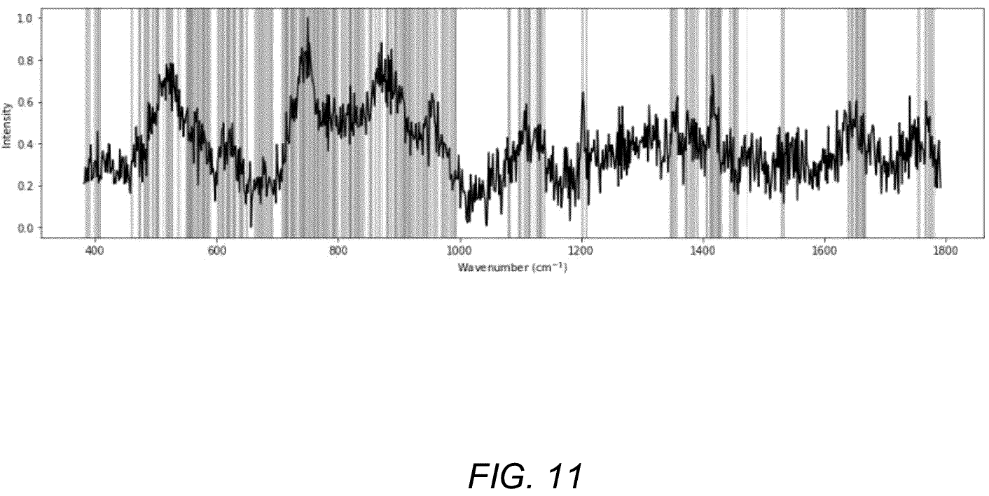

The ant colony optimization process in accordance with several embodiments produces every feature and its final pheromone value. Visualization of most significant features obtained through ACO-CNN in accordance with an embodiment is illustrated in FIG. 11. 250 features with the greatest pheromone values can be selected and visually displayed in FIG. 11. Relative to the filter feature selection approaches, ACO can yield more distributed features. In some embodiments, less bands of consecutive features ascertained to be significant can be observed. Since consecutive features in the Raman spectra tend to be slightly correlated, ACO effectively obtains subsets of features with minimized correlation.

With this subset of selected features, certain embodiments run the CNN model to evaluate its classification accuracy. Using the 250 ACO-CNN selected features, the model can yield about 85.7% antibiotic level accuracy. A less correlated discriminative subset of the original features thereby yields better performance relative to filter feature selection approaches.

### Example 10: Ablative Analysis

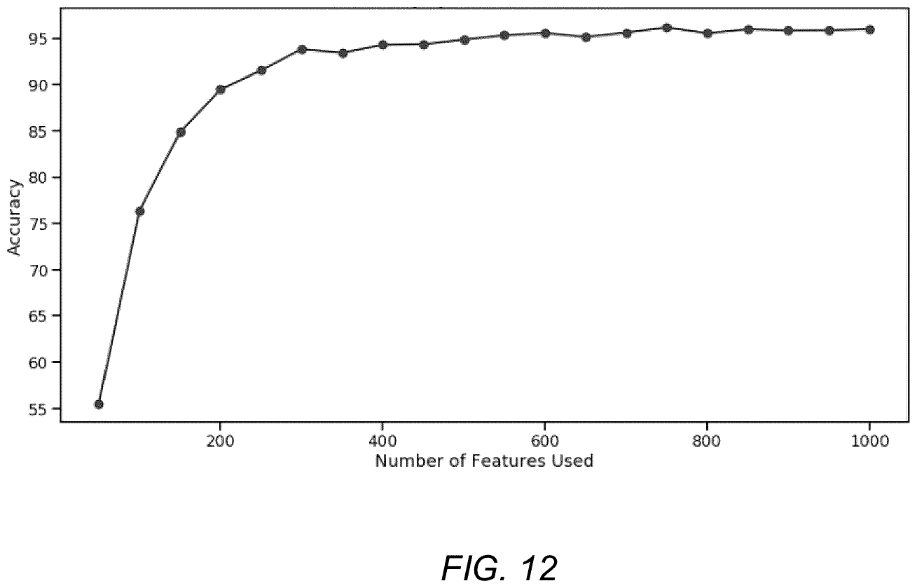

250 features that are most significant for accurate pathogen identification can be selected in accordance with several embodiments. However, finding a more optimal number of features of select may be important to maximize accuracy and minimize computation cost. Many embodiments run the model using different subset sizes of the selected features. Some embodiments utilize the feature significances obtained through the ANOVA test when selecting features. ANOVA feature selection shows good filter feature selection results and is more computationally efficient to obtain relative to ACO-CNN. Several embodiments select the top 50, 100, . . . , 950 features from the input spectra and run the CNN model to evaluate their accuracies in classification. Hyperparameter optimization of feature subset size in accordance with an embodiment of the invention is illustrated in FIG. 12. In FIG. 12, the results indicate that using all the features is not as effective as using the top 750 features. Utilizing 750 of the top features produce marginally better results at about 96.2% antibiotic level accuracy over the 96.0% accuracy using all the features. Furthermore, after 300 features, the accuracy scores relatively stagnate. As such, to best optimize computation time and accuracy, it may be best to select a subset of size 300 features instead of 250 features.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “set” and “subset” refer to a collection of one or more objects. Thus, for example, a subset of features can include a single feature or multiple features.

As used herein, the term “about” is used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A vibrational spectroscopy platform comprising:
a sample light source;
an image sensor disposed a set distance from a sample; and
at least one optical filter disposed in line with the image sensor;
wherein the sample light source is configured to deliver a full vibrational spectrum of the sample to the image sensor; and
wherein a light from the sample light source passes through the at least one optical filter prior to reaching the image sensor, and
wherein the at least one optical filter selects a set of spectral bands from the full vibrational spectrum of the sample for detection by the image sensor such that the set distance between the image sensor and the sample is shorter than required for detection of the full vibrational spectrum.

2. The platform of claim 1, wherein the vibrational spectroscopy platform is a Raman spectrometer.

3. The platform of claim 1, wherein the sample light source is a continuous wave laser or a pulsed laser.

4. The platform of claim 1, wherein the image sensor comprises a pixel binning process.

5. The platform of claim 4, wherein the pixel binning process is selected from the group consisting of 2-pixel binning, 4-pixel binning, 8-pixel binning, and any combinations thereof.

6. The platform of claim 1, wherein the image sensor is a CCD image sensor.

7. The platform of claim 1, wherein the image sensor comprises a hyperspectral imaging scheme.

8. The platform of claim 1, wherein the at least one optical filter is integrated on the image sensor.

9. The platform of claim 1, wherein the at least one optical filter comprises a thin film or a dielectric metasurface.

10. The platform of claim 1, wherein the set of spectral bands comprises from 250 bands to 750 bands.

11. The platform of claim 1, wherein the set of spectral bands are selected using a machine learning process on a computer.

12. The platform of claim 11, wherein the machine learning process comprises a feature selection process selected from the group consisting of ANOVA, x², mutual information, and ant colony optimization.

13. A method to identify a pathogen using a Raman spectrometer comprising:
obtaining a plurality of Raman spectra of pathogens as input;
applying a feature selection process to the plurality of Raman spectra to select a plurality of features on a computer;
classifying and ranking the plurality of features by classification accuracy;
determining a set of features based on the ranking as output; and
applying the set of features to identify the pathogen;
wherein the classifying and ranking process comprises training a convolutional neural network with the plurality of features.

14. The method of claim 13, wherein the feature selection process is selected from the group consisting of ANOVA, x², mutual information, and ant colony optimization.

15. The method of claim 13, wherein the plurality of Raman spectra comprises Raman spectra from 30 bacteria.

16. The method of claim 15, wherein the bacteria are selected from the group consisting of Escherichia coli, Klebsiella pneumoniae, Klebsielle aerogenes, Enterobacter cloacae, Proteus mirabilis, Serratia marcescens, Pseudomonas aeruginosa, Staphylococcus aureus, Staphylococcus epidermidis, Staphylococcus lugdunensis, Streptococcus pneumoniae, Streptococcus pyogenes, Streptococcus agalactiae, Streptococcus dysgalactiae, Streptococcus sanguinis, Enterococcus faecalis, Enterococcus faecium, Salmonella enterica, Candida albicans, Candida glabrata, Mycobacterium tuberculosis, and any combinations thereof.

17. The method of claim 13, wherein the set of features comprises from 250 features to 750 features.

18. The method of claim 13, wherein the set of features comprises 300 features.

19. The method of claim 13, wherein the pathogen is selected from the group consisting of bacterium, virus, fungus, microorganism, yeast, circulating tumor cell, exosome, extracellular vesicle, and biomarker.

20. The method of claim 13, wherein the plurality of features is at least ¼ of all features in a full Raman spectrum.

21. The method of claim 13, wherein the feature selection process reduces features from the plurality of Raman spectra to at least 250 features.

22. The method of claim 13, wherein an identification accuracy of the pathogen using the set of features is at least 92%.
